(19) United States
(12) Patent Application Publication
(10) Pub. No.: US 2025/0199187 A1
(43) Pub. Date: Jun. 19, 2025

(54) POSITION CORRECTION DEVICE, POSITION CORRECTION SYSTEM, AND POSITION CORRECTION METHOD

(71) Applicant: SEIKO EPSON CORPORATION, Tokyo (JP)

(72) Inventor: Hiroshi UOZUMI, MATSUMOTO-SHI (JP)

(73) Assignee: SEIKO EPSON CORPORATION, Tokyo (JP)

(21) Appl. No.: 18/983,300

(22) Filed: Dec. 16, 2024

(30) Foreign Application Priority Data
Dec. 18, 2023 (JP) 2023-213078

(51) Int. Cl. G01S 19/41; G01S 19/49

(52) U.S. Cl. CPC G01S 19/41; G01S 19/49

(57) ABSTRACT

A mobile communication device includes a first acquisition unit, a determination unit, and a correction unit. The first acquisition unit is attached to a contestant participating in a marathon where the contestant moves along a course, acquires competition position information indicating a position of the contestant from a GNSS system, and acquires fixed position information from a fixed communication device that is arranged at a specific position in the course and stores the fixed position information indicating the specific position. The determination unit determines whether a difference between a position of the contestant that is indicated by the contestant position information and the specific position is a first threshold value or more when the contestant arrives at the specific position. When the difference is the first threshold value or more, the correction unit corrects the contestant position information, based on the specific position.

The present application is based on, and claims priority from JP Application Serial Number 2023-213078, filed Dec. 18, 2023, the disclosure of which is hereby incorporated by reference herein in its entirety.

### BACKGROUND

### 1. Technical Field

The present disclosure relates to a position correction device, a position correction system, and a position correction method.

### 2. Related Art

JP-A-2023-56634 describes that position information relating to a contestant is acquired by a GPS reception device attached to the contestant.

In the technique described in JP-A-2023-56634, even when position information acquired by a GPS receiver contains an error, the position information cannot be corrected.

### SUMMARY

An aspect of the present disclosure is a position correction device including a first acquisition unit attached to a contestant participating in a competition in which the contestant moves along a course and configured to acquire, from a GNSS system, first position information indicating a position of the contestant, a second acquisition unit arranged at a specific position in the course and configured to acquire second position information from a second communication device that stores the second position information indicating the specific position, a determination unit configured to determine whether a difference between a position of the contestant that is indicated by the first position information and the specific position is a first threshold value or more, and a correction unit configured to correct the first position information, based on the specific position, when the determination unit determines that the difference is the first threshold value or more.

Another aspect of the present disclosure is a position correction system including a first communication device being attached to a contestant participating in a competition in which the contestant moves along a course and configured to acquire, from a GNSS system, first position information indicating a position of the contestant, a second communication device arranged at a specific position in the course and configured to communicate with the first communication device and acquire second position information indicating the specific position, and an information processing device configured to communicate with the first communication device and the second communication device, wherein, when the contestant arrives at the specific position, the first communication device acquires the first position information, and, when a difference between a position of the contestant that is indicated by the first position information and the specific position is a first threshold value or more, at least one of the first communication device or the information processing device corrects the first position information, based on the specific position.

Further, Another aspect of the present disclosure is a position correction method of a position correction system including a first communication device being attached to a contestant participating in a competition in which the contestant moves along a course and configured to acquire, from a GNSS system, first position information indicating a position of the contestant, a second communication device arranged at a specific position in the course and configured to communicate with the first communication device and acquire second position information indicating the specific position, and an information processing device configured to communicate with the first communication device and the second communication device, the position correction method including an acquisition step for acquiring the first position information by the first communication device when the contestant arrives at the specific position, and a correction step for correcting the first position information by at least one of the first communication device or the information processing device, based on the specific position, when a difference between a position of the contestant that is indicated by the first position information and the specific position is a first threshold value or more.

### BRIEF DESCRIPTION OF THE DRAWINGS

FIG. 1 is a diagram illustrating an example of a configuration of a position correction system according to the embodiment.

FIG. 2 is a diagram illustrating an example of a configuration of a mobile communication device.

FIG. 3 is a diagram illustrating an example of a configuration of a fixed communication device.

FIG. 4 is a diagram illustrating an example of a configuration of a server device.

FIG. 5 is a flowchart illustrating an example of processing of the mobile communication device.

### DESCRIPTION OF EMBODIMENTS

The embodiment is described below with reference to the drawings.

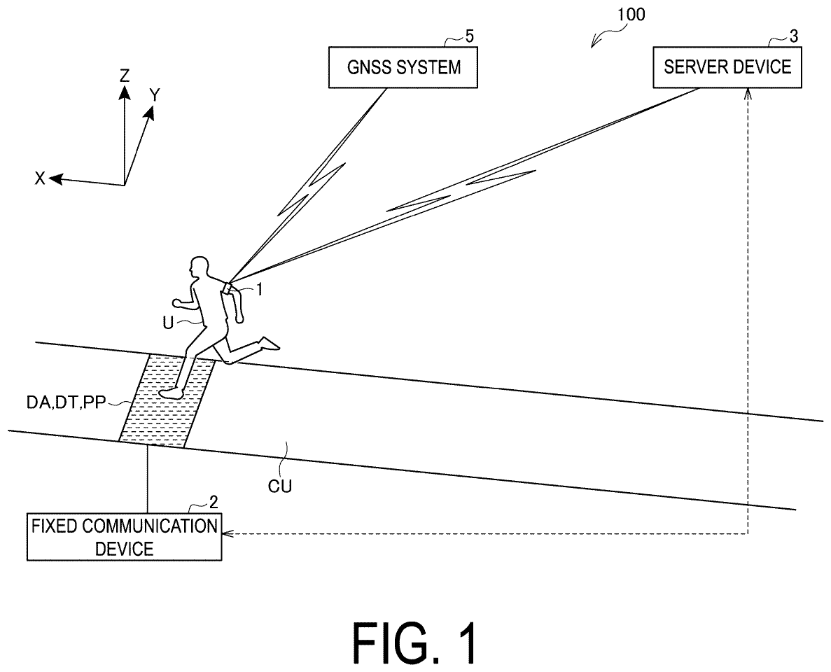

First, with reference to FIG. 1, a configuration of the position correction system 100 according to the embodiment is described. FIG. 1 is a diagram illustrating an example of the position correction system 100 according to the embodiment. As illustrated in FIG. 1, the position correction system 100 includes a mobile communication device 1, a fixed communication device 2, and a server device 3.

The mobile communication device 1 is attached to each of contestants U. For example, the mobile communication device 1 is attached to an upper arm of each of the contestants U.

Each of the contestants U participates in a competition in which the contestants move along a course CU. For example, the competition is a marathon. In the following description, a case where the competition is a marathon is described. The mobile communication device 1 acquires contestant position information PSM from a global navigation satellite system (GNSS) system 5. The contestant position information PSM indicates a position of the contestant U.

The contestant position information PSM corresponds to an example of the “first position information”.

For example, the mobile communication device 1 acquires the contestant position information PSM from the GNSS system 5 at a predetermined time interval. For example, the predetermined time interval is one second.

Further, when the contestant position information PSM is acquired from the GNSS system 5, the mobile communication device 1 acquires contestant date and time information from the GNSS system 5. The contestant date and time information indicate a date and time corresponding to the contestant position information PSM.

Further, the mobile communication device 1 transmits the contestant position information PSM in association with the contestant date and time information, to the server device 3. The mobile communication device 1 transmits the contestant position information PSM and the contestant date and time information to the server device 3 at a predetermined time interval. For example, the predetermined time interval is 20 seconds.

Further, for example, when the contestant U arrives at a specific position PP, the mobile communication device 1 acquires the contestant position information PSM and the contestant date and time information from the GNSS system 5, and transmits the contestant position information PSM and the contestant date and time information to the server device 3.

Note that, when the contestant U arrives at the specific position PP, in other words, when the contestant U enters the detection region DA arranged in the course CU, the mobile communication device 1 communicates with the fixed communication device 2. For example, a pressure sensor is installed in the detection region DA, and detects entry of the contestant U into the detection region DA. The detection region DA is arranged at the specific position PP.

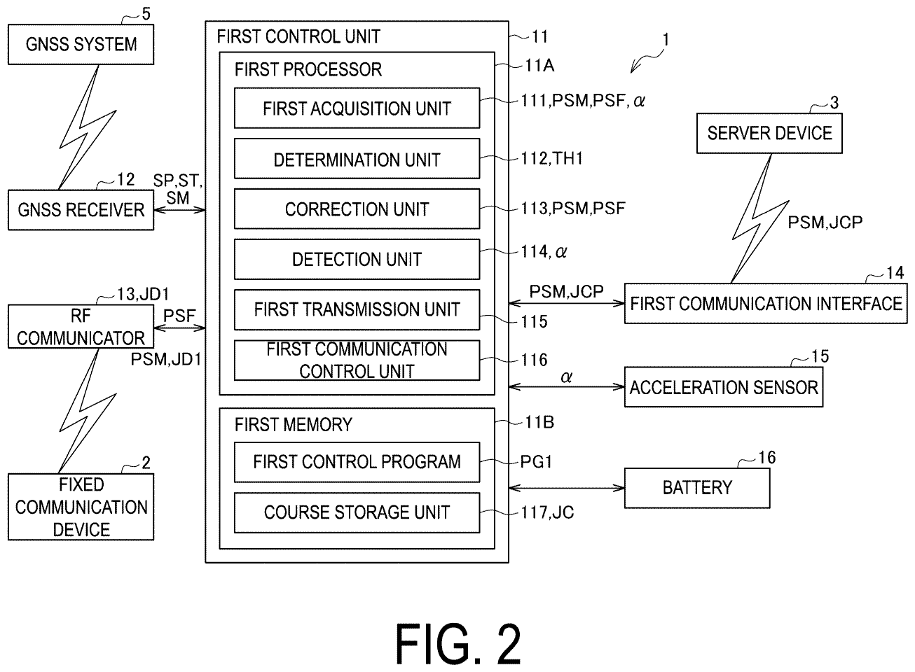

A configuration of the mobile communication device 1 is further described with reference to FIG. 2.

The mobile communication device 1 corresponds to an example of the “position correction device”.

Further, the mobile communication device 1 corresponds to an example of the “first communication device”.

When the contestant U arrives at the specific position PP, the fixed communication device 2 communicates with the mobile communication device 1. For example, when the contestant U arrives at the specific position PP, the fixed communication device 2 acquires first identification information JD1 from the mobile communication device 1. The first identification information JD1 is identification information for identifying the mobile communication device 1. Further, when the contestant U arrives at the specific position PP, the fixed communication device 2 acquires fixed date and time information TMF from the GNSS system 5. Further, the fixed communication device 2 transmits the first identification information JD1 and the fixed date and time information TMF that are acquired, and fixed position information PSF to the server device 3.

The fixed date and time information TMF indicates a date and time when the contestant U arrives at the specific position PP. The fixed position information PSF indicates the position of the detection region DA.

For example, the fixed communication device 2 is arranged at a predetermined distance interval from the start position of the marathon along the course CU. In other words, for example, the specific position PP is a position at the predetermined distance interval from the start position of the marathon along the course CU. For example, the predetermined distance may be 10 km. Further, the predetermined distance may be 5 km.

The fixed communication device 2 corresponds to an example of the “second communication device”.

The fixed position information PSF corresponds to an example of the “second position information”.

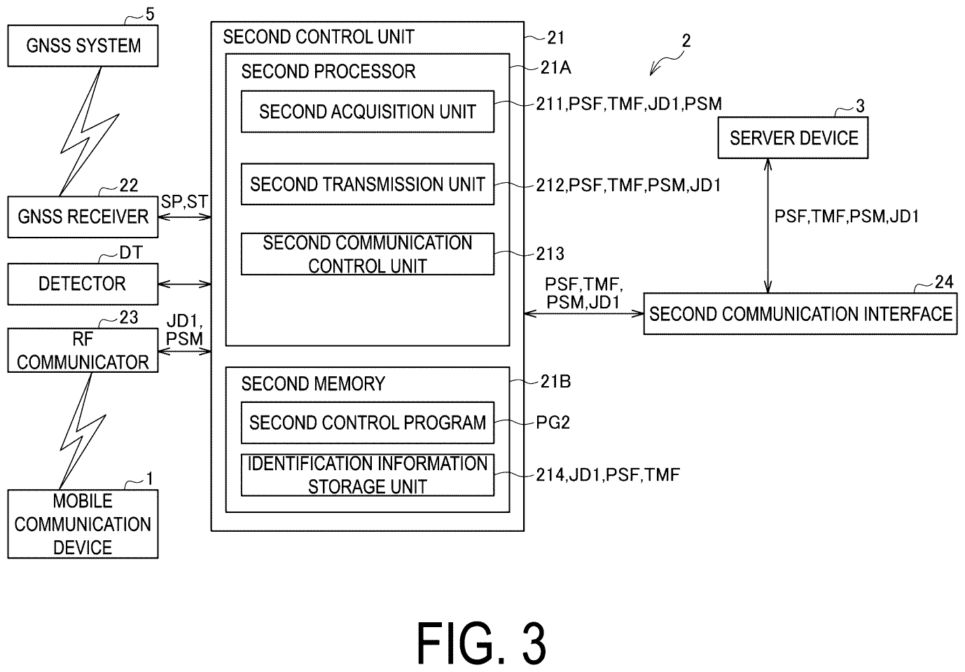

A configuration of the fixed communication device 2 is further described with reference to FIG. 3.

The server device 3 receives the contestant position information PSM from the mobile communication device 1, and receives the fixed position information PSF from the fixed communication device 2.

Further, when the contestant position information PSM is received from the mobile communication device 1, the server device 3 receives the contestant date and time information in association with the contestant position information PSM, from the mobile communication device 1. When the fixed position information PSF is received from the fixed communication device 2, the server device 3 receives the fixed date and time information TMF in association with the fixed position information PSF, from the fixed communication device 2. Further, the server device 3 receives the first identification information JD1 from the fixed communication device 2. The first identification information JD1 is information for identifying the mobile communication device 1.

The server device 3 corresponds to an example of the “information processing device”.

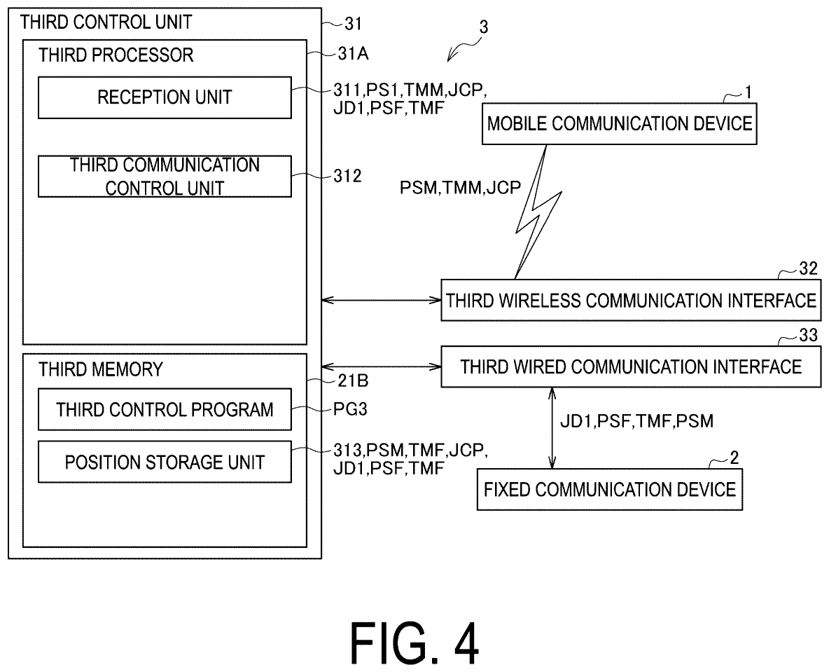

A configuration of the server device 3 is further described with reference to FIG. 4.

Next, with reference to FIG. 2, a configuration of the mobile communication device 1 is described. FIG. 2 is a diagram illustrating an example of a configuration of the mobile communication device 1. As illustrated in FIG. 2, the mobile communication device 1 includes a first control unit 11, a GNSS receiver 12, a radio frequency (RF) communicator 13, a first communication interface 14, an acceleration sensor 15, and a battery 16.

The first control unit 11 controls each component of the mobile communication device 1. The battery 16 supplies power to each component of the mobile communication device 1 in accordance with an instruction of the first control unit 11.

The GNSS receiver 12 receives a GNSS signal from the GNSS system 5 in accordance with an instruction of the first control unit 11. The GNSS receiver 12 includes an antenna. The GNSS receiver 12 outputs the GNSS signal received from the GNSS system 5, to the first control unit 11.

The GNSS signal includes a position signal SP, a date and time signal ST, and a number signal SM. The position signal SP corresponds to the contestant position information PSM indicating the position of the GNSS receiver 12. The date and time signal ST indicates a date and time corresponding to the position signal SP. In other words, the date and time signal ST indicates a date and time when the GNSS receiver 12 receives the position signal SP. The number signal SM indicates the number SN of satellites used in calculating the position information PS.

Further, the GNSS receiver 12 is turned on and off in accordance with an instruction of the first control unit 11. For example, the GNSS receiver 12 is configured by an integrated circuit (IC).

When the contestant U arrives at the specific position PP, the RF communicator 13 communicates with the fixed communication device 2. For example, the RF communicator 13 stores the first identification information JD1. When the contestant U arrives at the specific position PP, in other words, when the contestant U enters the detection region DA arranged in the course CU, the RF communicator 13 transmits the first identification information JD1 to the fixed communication device 2. The first identification information JD1 is identification information for identifying the mobile communication device 1.

The RF communicator 13 corresponds to an example of the “identification storage unit”.

The first communication interface 14 includes an antenna, a connector, and an interface circuit, and is coupled to the first control unit 11. The first communication interface 14 is an interface for communicating with the server device 3. For example, the first communication interface 14 is an interface for communicating with the server device 3 in accordance with the Long Term Evolution (LTE) standard (trademark).

The acceleration sensor 15 detects acceleration α that is generated as the contestant U runs. For example, the acceleration α includes the acceleration αX and acceleration αY in a horizontal direction and acceleration αZ in a vertical direction.

FIG. 1 illustrates an X-axis, a Y-axis, and a Z-axis. The X-axis, the Y-axis, and the Z-axis are orthogonal to one another. The X-axis and the Y-axis are parallel to the horizontal direction, and the Z-axis is parallel to the vertical direction. The X-axis is parallel to the front-and-rear direction of the contestant U. The Y-axis is parallel to the right-and-left direction of the contestant U. The positive direction of the X-axis indicates the frontward direction of the contestant U. The positive direction of the Y-axis indicates the rightward direction of the contestant U. The positive direction of the Z-axis indicates the upward direction of the contestant U.

For example, the acceleration αX indicates acceleration in the frontward direction of the contestant U. For example, the acceleration αY indicates acceleration in the right ward direction of the contestant U. The acceleration αZ indicates acceleration in the upward direction of the contestant U. The acceleration sensor 15 outputs a signal indicating the acceleration α to the first control unit 11.

The first control unit 11 includes a first processor 11A and a first memory 11B.

The first memory 11B is a storage device that stores a program to be executed by the first processor 11A or data in a non-volatile manner. The first memory 11B is configured by a magnetic storage device, a semiconductor storage element such as a flash read-only memory (ROM), or other types of non-volatile storage device. Further, the first memory 11B may include a random access memory (RAN) that constitutes a work area of the first processor 11A. The first memory 11B stores data to be processed by the first control unit 11, a first control program PG1 to be executed by the first processor 11A, and the like.

The first processor 11A may be configured by a single processor, or it may be possible to employ a configuration in which a plurality of processors function as the first processor 11A. The first processor 11A executes the first control program PG1 to control each component of the mobile communication device 1.

The first processor 11A may be configured by a system on chip (SoC) integrated with a part or an entirety of the first memory 11B, or with other circuits. Further, the first processor 11A may be configured by a combination of a central processing unit (CPU) that executes a program and a digital signal processor (DSP) that executes predetermined computation processing. It may be possible to employ a configuration in which all of the functions of the first processor 11A are implemented in hardware, or all of the functions of the first processor 11A may be configured by using a programmable device.

In the following description, description is made on a case where the first processor 11A executes the first control program PG1 to control each component of the mobile communication device 1.

Next, with reference to FIG. 2, a functional configuration of the first control unit 11 is described. The first control unit 11 includes a first acquisition unit 111, a determination unit 112, a correction unit 113, a detection unit 114, a first transmission unit 115, a first communication control unit 116, and a course storage unit 117.

Specifically, the first processor 11A executes the first control program PG1 to function as the first acquisition unit 111, the determination unit 112, the correction unit 113, the detection unit 114, the first transmission unit 115, and the first communication control unit 116. Further, the first processor 11A executes the first control program PG1 so that the first memory 11B functions as the course storage unit 117.

The course storage unit 117 stores course information JC in advance. The course information JC indicates the course CU. When the competition is a marathon, the course CU corresponds to a road or the like. On the road forming the course CU, a position in a high-and-low direction is also changed, as well as a position in a horizontal plane corresponding to so-called a latitude and a longitude. In view of this, the course storage unit 117 stores three-dimensional information as the course information JC.

The first acquisition unit 111 acquires the contestant position information PSM and the contestant date and time information from the GNSS system 5 via the GNSS receiver 12. For example, the first acquisition unit 111 acquires the contestant position information PSM and the contestant date and time information from the GNSS system 5 at a predetermined time interval. Note that the contestant position information PSM indicates a position of the contestant U in the course CU. For example, the predetermined time interval is one second. In the following description, a case where the predetermined time interval is one second is described.

Further, when the contestant U arrives at the specific position PP, and the RF communicator 13 communicates with the fixed communication device 2, the first acquisition unit 111 acquires the contestant position information PSM and the contestant date and time information from the GNSS system 5 via the GNSS receiver 12.

The first acquisition unit 111 determines whether a communication state between the GNSS receiver 12 and the GNSS system 5 is satisfactory. For example, when the GNSS receiver 12 receives the GNSS signal from the GNSS system 5, the first acquisition unit 111 determines whether the communication state is satisfactory, based on the following condition.

Condition; the number SN of satellites that receive, from the GNSS system 5, the position signal SP whose SN ratio is a second threshold value TH2 or more is less than four.

Note that, for example, the second threshold value TH2 “10”.

When the condition described above is satisfied, the first acquisition unit 111 determines that the communication state between the GNSS receiver 12 and the GNSS system 5 is not satisfactory.

When the first acquisition unit 111 determines that the communication state between the GNSS receiver 12 and the GNSS system 5 is not satisfactory, the first acquisition unit 111 acquires the contestant position information PSM, based on the detection result of the detection unit 114. When the first acquisition unit 111 determines that the communication state between the GNSS receiver 12 and the GNSS system 5 is not satisfactory, the first acquisition unit 111 acquires, based on movement velocity V of the contestant U that is detected by the detection unit 114, for example.

Further, when the contestant U arrives at the specific position PP, and the RF communicator 13 communicates with the fixed communication device 2, the first acquisition unit 111 acquires the fixed position information PSF and the fixed date and time information TMF from the fixed communication device 2.

The first acquisition unit 111 corresponds to an example of the “first acquisition unit” and the “second acquisition unit”.

When the contestant U arrives at the specific position PP, the determination unit 112 determines whether a difference ΔL between the position of the contestant U that is indicated by the contestant position information PSM and the specific position PP is a first threshold value TH1 or more. The difference ΔL indicates a distance between the position of the contestant U that is indicated by the contestant position information PSM and the specific position PP.

The fixed position information PSF indicates the specific position PP. In view of this, for example, when the contestant U arrives at the specific position PP, the determination unit 112 determines whether the difference ΔL between the position of the contestant U that is indicated by the contestant position information PSM and the specific position PP that is indicated by the fixed position information PSF is the first threshold value TH1 or more.

For example, the first threshold value TH1 is 1 m.

When the determination unit 112 determines that the difference ΔL is the first threshold value TH1 or more, the correction unit 113 corrects the contestant position information PSM, based on the specific position PP. For example, when the determination unit 112 determines that the difference ΔL is the first threshold value TH1 or more, the correction unit 113 corrects the position of the contestant U that is indicated by the contestant position information PSM, to the specific position PP. In other words, for example, the correction unit 113 corrects the contestant position information PSM so that the position of the contestant U that is indicated by the contestant position information PSM matches with the specific position PP.

The detection unit 114 detects movement of the contestant U, based on the detection result of the acceleration sensor 15. For example, the detection unit 114 detects the movement velocity V of the contestant U, based on the acceleration αX indicating the acceleration in the front-and-rear direction of the contestant U. For example, the detection unit 114 detects the movement velocity V by integrating the acceleration αX over time.

The first transmission unit 115 transmits the contestant position information PSM in association with the contestant date and time information, to the server device 3. For example, the first transmission unit 115 transmits the contestant position information PSM and the contestant date and time information to the server device 3 at a predetermined time interval. For example, the predetermined time interval is 20 seconds. In the following description, a case where the predetermined time interval is 20 seconds is described.

Further, when the RF communicator 13 communicates with the fixed communication device 2, the first transmission unit 115 associated the contestant position information PSM acquired by the first acquisition unit 111 with the contestant date and time information, and transmits those pieces of information to the server device 3. Note that, when the first acquisition unit 111 determines that the communication state between the GNSS receiver 12 and the GNSS system 5 is not satisfactory, the first transmission unit 115 transmits the contestant position information PSM and the contestant date and time information to the server device 3 via the fixed communication device 2.

Further, when the determination unit 112 determines that the difference ΔL is the first threshold value TH1 or more, the first transmission unit 115 transmits the contestant position information PSM corrected by the correction unit 113 and correction completion information JCP to the server device 3. The correction completion information JCP indicates that the contestant position information PSM is corrected by the correction unit 113.

Further, when the first acquisition unit 111 determines that the communication state between the GNSS receiver 12 and the GNSS system 5 is not satisfactory, the first transmission unit 115 transmits the contestant position information PSM and the first identification information JD1 to the server device 3 via the fixed communication device 2.

The first transmission unit 115 corresponds to an example of the “transmission unit”.

The first communication control unit 116 controls communication of the GNSS receiver 12 with the GNSS system 5. Further, the first communication control unit 116 controls communication of the RF communicator 13 with the fixed communication device 2. Further, the first communication control unit 116 controls communication of the first communication interface 14 with the server device 3.

Next, with reference to FIG. 3, a configuration of the fixed communication device 2 is described. FIG. 3 is a diagram illustrating an example of a configuration of the fixed communication device 2. As illustrated in FIG. 3, the fixed communication device 2 includes a second control unit 21, a GNSS receiver 22, a detector DT, an RF communicator 23, and a second communication interface 24.

The second control unit 21 controls each component of the fixed communication device 2.

The GNSS receiver 22 receives the GNSS signal from the GNSS system 5 in accordance with an instruction of the second control unit 21. The GNSS receiver 22 includes an antenna. The GNSS receiver 22 outputs the GNSS signal received from the GNSS system 5, to the second control unit 21.

The GNSS signal includes the position signal SP and the date and time signal ST. The position signal SP corresponds to the fixed position information PSF indicating the position of the GNSS receiver 22. The date and time signal ST indicates a date and time corresponding to the position of the GNSS receiver 22.

For example, before a marathon starts, the GNSS receiver 22 receives the position signal SP from the GNSS system 5, and acquires the fixed position information PSF.

For example, the GNSS receiver 22 is configured by an IC.

When the contestant U arrives at the specific position PP, in other words, when the contestant U enters the detection region DA, the RF communicator 23 communicates with the mobile communication device 1. When the contestant U enters the detection region DA, the RF communicator 23 receives the first identification information JD1 from the mobile communication device 1, for example.

The detector DT is arranged in the detection region DA illustrated in FIG. 1, and detects entry of the contestant U into the detection region DA. The detection region DA is arranged at the specific position PP in the course CU. For example, the detector DT detects entry of the contestant U into the detection region DA, in other words, arrival of the contestant U at the specific position PP. For example, the detector DT is configured by a pressure sensor. The detector DT outputs, to the second control unit 21, a detection signal indicating entry of the contestant U into the detection region DA.

The second communication interface 24 includes a connector and an interface circuit, and is coupled to the second control unit 21. The second communication interface 24 is an interface for communicating with the server device 3. The second communication interface 24 communicates with the server device 3 in accordance with the Ethernet (registered trademark) standard, for example.

The second control unit 21 includes a second processor 21A and a second memory 21B.

The second memory 21B is a storage device that stores a program to be executed by the second processor 21A or data in a non-volatile manner. The second memory 21B is configured by a magnetic storage device, a semiconductor storage element such as a flash ROM, or other types of non-volatile storage device. Further, the second memory 21B may include a RAM configuring a work area of the second processor 21A. The second memory 21B stores data to be processed by the second control unit 21, a second control program PG2 to be executed by the second processor 21A, and the like.

The second processor 21A may be configured by a single processor, or it may be possible to employ a configuration in which a plurality of processors function as the second processor 21A. The second processor 21A executes the second control program PG2 to control each component of the fixed communication device 2.

The second processor 21A may be configured by a system on chip (SoC) integrated with a part or an entirety of the second memory 21B, or with other circuits. Further, the second processor 21A may be configured by a combination of a CPU that executes a program and a DSP that executes predetermined computation processing. It may be possible to employ a configuration in which all of the functions of the second processor 21A are implemented in hardware, or all of the functions of the second processor 21A may be configured by using a programmable device.

In the following description, description is made on a case where the second processor 21A executes the second control program PG2 to control each component of the fixed communication device 2.

Next, with reference to FIG. 3, a functional configuration of the second control unit 21 is described. The second control unit 21 includes a second acquisition unit 211, a second transmission unit 212, a second communication control unit 213, and an identification information storage unit 214.

Specifically, the second processor 21A executes the second control program PG2 to function as the second acquisition unit 211, the second transmission unit 212, and the second communication control unit 213. Further, the second processor 21A executes the second control program PG2 so that the second memory 21B functions as the identification information storage unit 214.

The identification information storage unit 214 stores the first identification information JD1 received from the mobile communication device 1. For example, before a marathon starts, the identification information storage unit 214 stores the fixed position information PSF. The fixed position information PSF indicates the position of the GNSS receiver 22. Further, the identification information storage unit 214 may store the fixed date and time information TMF in association with the first identification information JD1. When the contestant U enters the detection region DA, the fixed date and time information TMF is acquired from the GNSS system 5 by the GNSS receiver 22.

The first identification information JD1 and the fixed date and time information TMF are acquired by the second acquisition unit 211, and are stored in the identification information storage unit 214 by the second acquisition unit 211.

When the contestant U arrives at the specific position PP, and the mobile communication device 1 communicates with the RF communicator 23, the second acquisition unit 211 acquires the first identification information JD1 from the mobile communication device 1. Further, the mobile communication device 1 communicates with the RF communicator 23, the second acquisition unit 211 acquires the fixed date and time information TMF from the GNSS system 5 via the GNSS receiver 22.

The second acquisition unit 211 stores, in the identification information storage unit 214, the fixed date and time information TMF in association with the first identification information JD1.

The second transmission unit 212 transmits the first identification information JD1 and the fixed position information PSF that are acquired by the second acquisition unit 211 and the fixed date and time information TMF to the server device 3.

Further, when the first acquisition unit 111 of the mobile communication device 1 determines that the communication state between the GNSS receiver 12 and the GNSS system 5 is not satisfactory, the second acquisition unit 211 acquires the contestant position information PSM and the first identification information JD1. Further, the second transmission unit 212 transmits the contestant position information PSM and the first identification information JD1 to the server device 3.

The second communication control unit 213 controls communication of the GNSS receiver 22 with the GNSS system 5. Further, the second communication control unit 213 controls communication of the RF communicator 23 with the mobile communication device 1. Further, the second communication control unit 213 controls communication of the second communication interface 24 with the server device 3.

Next, with reference to FIG. 4, a configuration of the server device 3 is described. FIG. 4 is a diagram illustrating an example of a configuration of the server device 3.

As illustrated in FIG. 4, the server device 3 includes a third control unit 31, a third wireless communication interface 32, and a third wired communication interface 33.

The third control unit 31 controls each component of the server device 3.

The third wireless communication interface 32 includes an antenna, a connector, and an interface circuit, and is coupled to the third control unit 31. The third wireless communication interface 32 is an interface for communicating with the mobile communication device 1. The third wireless communication interface 32 is an interface for communicating with the mobile communication device 1 in accordance with the LTE (registered trademark) standard, for example.

The third wired communication interface 33 includes a connector and an interface circuit, and is coupled to the third control unit 31. The third wired communication interface 33 is an interface for communicating with the fixed communication device 2. The third wired communication interface 33 communicates with the fixed communication device 2 in accordance with the Ethernet (registered trademark) standard, for example.

Note that the server device 3 and the fixed communication device 2 are communicably coupled to each other via at least one of the Internet, the Wide Area Network (WAN), or the Local Area Network (LAN) in accordance with the Ethernet (registered trademark) standard, for example.

The third control unit 31 includes a third processor 31A and a third memory 31B.

The third memory 31B is a storage device that stores a program to be executed by the third processor 31A or data in a non-volatile manner. The third memory 31B is configured by a magnetic storage device, a semiconductor storage element such as a flash ROM, or other types of non-volatile storage device. Further, the third memory 31B may include a RAM configuring a work area of the third processor 31A. The third memory 31B stores data to be processed by the third control unit 31, a third control program PG3 to be executed by the third processor 31A, and the like.

The third processor 31A may be configured by a single processor, or it may be possible to employ a configuration in which a plurality of processors function as the third processor 31A. The third processor 31A executes the third control program PG3 to control each component of the server device 3.

The third processor 31A may be configured by a system on chip (SoC) integrated with a part or an entirety of the third memory 31B, or with other circuits. Further, the third processor 31A may be configured by a combination of a CPU that executes a program and a DSP that executes predetermined computation processing. It may be possible to employ a configuration in which all of the functions of the third processor 31A are implemented in hardware, or all of the functions of the third processor 31A may be configured by using a programmable device.

In the following description, description is made on a case where the third processor 31A executes the third control program PG3 to control each component of the server device 3.

Next, with reference to FIG. 4, a functional configuration of the third control unit 31 is described. The third control unit 31 includes a reception unit 311, a third communication control unit 312, and a position storage unit 313.

Specifically, the third processor 31A executes the third control program PG3 to function as the reception unit 311 and the third communication control unit 312. Further, the third processor 31A executes the third control program PG3 so that the third memory 31B functions as the position storage unit 313.

The position storage unit 313 stores the contestant position information PSM received from the mobile communication device 1 and the contestant date and time information in association with each other. Further, the position storage unit 313 stores the first identification information JD1, the fixed position information PSF, and the fixed date and time information TMF, which are received from the fixed communication device 2, in association with each other.

The contestant position information PSM and the contestant date and time information are received from the mobile communication device 1 by the reception unit 311, and are stored in the position storage unit 313 by the reception unit 311. Further, the first identification information JD1, the fixed position information PSF, and the fixed date and time information TMF are received from the fixed communication device 2 by the reception unit 311, and are stored in the position storage unit 313 by the reception unit 311.

The reception unit 311 receives the contestant position information PSM and the contestant date and time information from the mobile communication device 1. Further, the reception unit 311 receives the first identification information JD1, the fixed date and time information TMF, and the fixed position information PSF from the fixed communication device 2. The fixed date and time information TMF indicates a date and time when the contestant U enters the detection region DA arranged in the course CU. The fixed position information PSF indicates the position of the detection region DA.

Further, when the determination unit 112 of the mobile communication device 1 determines that the difference ΔL is the first threshold value TH1 or more, the reception unit 311 receives the corrected contestant position information PSM and the correction completion information JCP from the mobile communication device 1.

Further, when the first acquisition unit 111 of the mobile communication device 1 determines that the communication state between the GNSS receiver 12 and the GNSS system 5 is not satisfactory, the reception unit 311 receives the contestant position information PSM and the first identification information JD1 from the fixed communication device 2.

The reception unit 311 stores the contestant position information PSM and the contestant date and time information that are received from the mobile communication device 1, in the position storage unit 313. Further, the reception unit 311 stores the first identification information JD1, the fixed date and time information TMF, and the fixed position information PSF that are received from the fixed communication device 2, in the position storage unit 313.

Further, when the determination unit 112 of the mobile communication device 1 determines that the difference ΔL is the first threshold value TH1 or more, the reception unit 311 stores the corrected contestant position information PSM and the correction completion information JCP in the position storage unit 313.

Further, when the first acquisition unit 111 of the mobile communication device 1 determines that the communication state between the GNSS receiver 12 and the GNSS system 5 is not satisfactory, the reception unit 311 stores the contestant position information PSM and the first identification information JD1 in the position storage unit 313.

The third communication control unit 312 controls communication of the third wireless communication interface 32 with the mobile communication device 1. Further, the third communication control unit 312 controls communication of the third wired communication interface 33 with the fixed communication device 2.

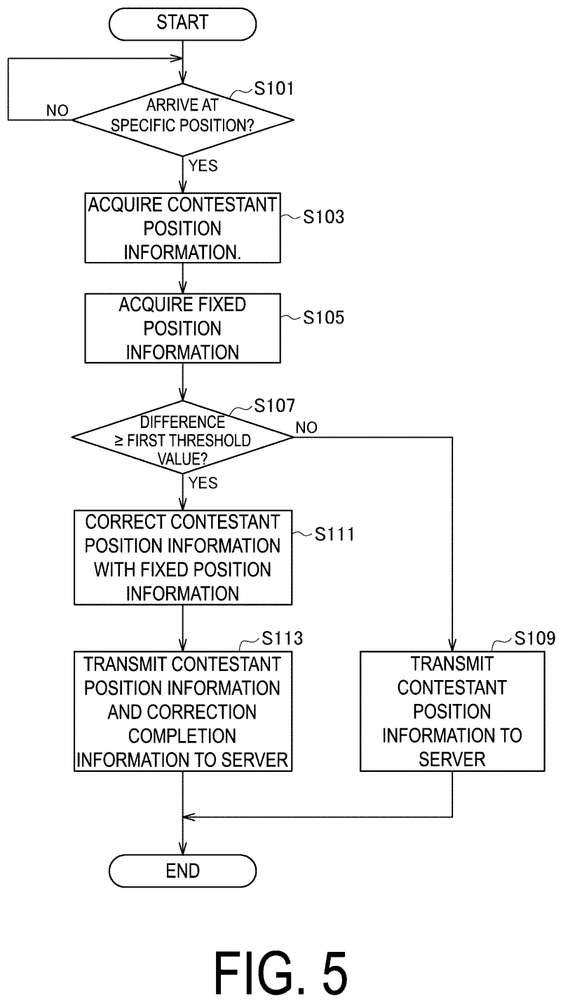

Next, with reference to FIG. 5, processing of the mobile communication device 1 is described. FIG. 5 is a flowchart illustrating an example of processing of the mobile communication device 1.

First, as illustrated in FIG. 5, in Step S101, the first acquisition unit 111 determines whether the contestant U to which the mobile communication device 1 is attached arrives at the specific position PP.

When the first acquisition unit 111 determines that the contestant U does not arrive at the specific position PP (Step S101; NO), the processing goes into a waiting state. When the first acquisition unit 111 determines that the contestant U arrives at the specific position PP (Step S101; YES), the processing proceeds to Step S103.

Further, in Step S103, the first acquisition unit 111 acquires the contestant position information PSM from the GNSS system 5 via the GNSS receiver 12.

Subsequently, in step S105, the first acquisition unit 111 acquires the fixed position information PSF from the fixed communication device 2.

Subsequently, in Step S107, the determination unit 112 determines whether the difference ΔL between the position of the contestant U that is indicated by the contestant position information PSM and the specific position PP is the first threshold value TH1 or more.

When it is determined that the difference ΔL is less than the first threshold value TH1 (Step S107; NO), the processing proceeds to Step S109.

Further, in Step S109, the first transmission unit 115 transmits the contestant position information PSM to the server device 3. Then, the processing is terminated.

When it is determined that the difference ΔL is the first threshold value TH1 or more (Step S107; YES), the processing proceeds to Step S111.

Further, in Step S111, the correction unit 113 corrects the contestant position information PSM, based on the position indicated by the fixed position information PSF. For example, the correction unit 113 corrects the position indicated by the contestant position information PSM, to the specific position PP. In other words, for example, the correction unit 113 corrects the contestant position information PSM so that the position indicated by the contestant position information PSM matches with the specific position PP.

Subsequently, in Step S113, the first transmission unit 115 transmits the contestant position information PSM corrected by the correction unit 113 and the correction completion information JCP to the server device 3. The correction completion information JCP indicates that the contestant position information PSM is corrected by the correction unit 113. Then, the processing is terminated.

Step S103 corresponds to an example of the “acquisition step”.

Step S111 corresponds to an example of the “correction step”.

### Present Embodiment, Operation, and Effects

As described above with reference to FIG. 1 to FIG. 5, the mobile communication device 1 according to the embodiment includes the first acquisition unit 111, the determination unit 112, and the correction unit 113. The first acquisition unit 111 is attached to the contestant U who participates in a marathon where the contestant U moves along the course CU, acquires the contestant position information PSM indicating the position of the contestant U from the GNSS system 5, and acquires the fixed position information PSF from the fixed communication device 2 that is arranged at the specific position PP in the course CU and stores the fixed position information PSF indicating the specific position PP. The determination unit 112 determines whether the difference ΔL between the position of the contestant U that is indicated by the contestant position information PSM and the specific position PP is the first threshold value TH1 or more when the contestant U arrives at the specific position PP. The correction unit 113 corrects the contestant position information PSM, based on the specific position PP, when the determination unit 112 determines that the difference ΔL is the first threshold value TH1 or more.

In other words, when the contestant U arrives at the specific position PP, it is determined whether the difference ΔL between the position of the contestant U that is indicated by the contestant position information PSM and the specific position PP is the first threshold value TH1 or more. Further, when the determination unit 112 determines that the difference ΔL is the first threshold value TH1 or more, the contestant position information PSM is corrected based on the specific position PP.

Therefore, the contestant position information PSM can be corrected appropriately.

Further, in the mobile communication device 1, when the determination unit 112 determines that the difference ΔL is the first threshold value TH1 or more, the correction unit 113 corrects the position indicated by the contestant position information PSM to the specific position PP.

Therefore, the position indicated by the contestant position information PSM is corrected to the specific position PP. Thus, with simple processing, the contestant position information PSM can be corrected appropriately.

Further, the mobile communication device 1 includes the first transmission unit 115 that transmits the contestant position information PSM to the server device 3. When the determination unit 112 determines that the difference ΔL is the first threshold value TH1 or more, the first transmission unit 115 transmits, to the server device 3, the corrected contestant position information PSM and the correction completion information JCP indicating that the contestant position information PSM is corrected by the correction unit 113.

Therefore, the correction completion information JCP is transmitted to the server device 3. Thus, the server device 3 can easily identify that the contestant position information PSM is the corrected contestant position information PSM.

Further, in the mobile communication device 1, the fixed position information PSF is acquired from the GNSS system 5 by the fixed communication device 2.

With this, the fixed position information PSF is acquired from the GNSS system 5. Thus, an administrator of the fixed communication device 2 or the like can acquire the fixed position information PSF easily and accurately. Therefore, a work load of an administrator of the fixed communication device 2 or the like for acquiring the fixed position information PSF can be alleviated.

Further, the mobile communication device 1 includes the course storage unit 117 that stores the course information JC indicating the course CU, and the first acquisition unit 111 acquires information indicating a position in the course CU as the contestant position information PSM.

Therefore, the information indicating the position in the course CU is acquired as the contestant position information PSM. Thus, as the contestant position information PSM, the position information indicating an appropriate position can be acquired.

Further, the mobile communication device 1 includes the acceleration sensor 15 and the detection unit 114 detects movement of the contestant U, based on the detection result of the acceleration sensor 15. In a case in which the first acquisition unit 111 acquires the contestant position information PSM from the GNSS system 5, when the number SN of satellites that receive, from the GNSS system 5, the position signal SP whose SN ratio is the second threshold value TH2 or more is less than four, the first acquisition unit 111 acquires the contestant position information PSM, based on the detection result of the detection unit 114.

When the number SN of satellites that receive, from the GNSS system 5, the position signal SP whose SN ratio is the second threshold value TH2 or more is less than four, the reception condition from the GNSS system 5 is not satisfactory. Therefore, when the reception state from the GNSS system 5 is not satisfactory, movement of the contestant U is detected based on the detection result of the acceleration sensor 15, and the contestant position information PSM is acquired based on the detection result. Thus, the appropriate contestant position information PSM can be acquired.

Further, the mobile communication device 1 includes the RF communicator 13 that stores the first identification information JD1 for identifying the mobile communication device 1. In a case in which the first acquisition unit 111 acquires the contestant position information PSM from the GNSS system 5, when the number SN of satellites that receive, from the GNSS system 5, the position signal SP whose SN ratio is the second threshold value TH2 or more is less than four, the first transmission unit 115 transmits the contestant position information PSM and the first identification information JD1 to the server device 3 via the fixed communication device 2.

When the number SN of satellites that receive, from the GNSS system 5, the position signal SP whose SN ratio is the second threshold value TH2 or more is less than four, the reception condition from the GNSS system 5 is not satisfactory. Further, when the reception state from the GNSS system 5 is not satisfactory, it can also be estimated that a communication state with the server device 3 is not satisfactory. Therefore, the contestant position information PSM and the first identification information JD1 are transmitted to the server device 3 via the fixed communication device 2. Thus, the contestant position information PSM and the first identification information JD1 can securely be transmitted to the server device 3.

The position correction system 100 according to the embodiment includes the mobile communication device 1, the fixed communication device 2, and the server device 3. The mobile communication device 1 is attached to the contestant U who participates in a marathon where the contestant U moves along the course CU, and acquires the contestant position information PSM indicating the position of the contestant U from the GNSS system 5. The fixed communication device 2 communicates with the mobile communication device 1, is arranged at the specific position PP in the course CU, and acquires the fixed position information PSF indicating the specific position PP. The server device 3 communicates with the mobile communication device 1 and the fixed communication device 2. When the contestant U arrives at the specific position PP, the mobile communication device 1 acquires the contestant position information PSM. When the difference ΔL between the position of the contestant U that is indicated by the contestant position information PSM and the specific position PP is the first threshold value TH1 or more, the mobile communication device 1 corrects the contestant position information PSM, based on the specific position PP.

In other words, when the contestant U arrives at the specific position PP, it is determined whether the difference ΔL between the position of the contestant U that is indicated by the contestant position information PSM and the specific position PP is the first threshold value TH1 or more. Further, when the determination unit 112 determines that the difference ΔL is the first threshold value TH1 or more, the contestant position information PSM is corrected based on the specific position PP.

Therefore, the contestant position information PSM can be corrected appropriately.

Further, in the position correction system 100, when the difference ΔL is the first threshold value TH1 or more, the mobile communication device 1 corrects the position indicated by the contestant position information PSM to the specific position PP.

With this, the position indicated by the contestant position information PSM is corrected to the specific position PP. Thus, with simple processing, the contestant position information PSM can be corrected appropriately.

Further, in the position correction system 100, the mobile communication device 1 acquires the fixed position information PSF from the fixed communication device 2, determines whether the difference ΔL between the position of the contestant U that is indicated by the contestant position information PSM and the specific position PP is the first threshold value TH1 or more, and transmits, to the server device 3, the corrected contestant position information PSM and the correction completion information JCP indicating that the contestant position information PSM is corrected, when the difference ΔL is the first threshold value TH1 or more.

Therefore, the correction completion information JCP is transmitted to the server device 3. Thus, the server device 3 can easily identify that the contestant position information PSM is the corrected contestant position information PSM.

Further, in the position correction system 100, the fixed position information PSF is acquired from the GNSS system 5 by the fixed communication device 2.

With this, the fixed position information PSF is acquired from the GNSS system 5. Thus, an administrator of the fixed communication device 2 or the like can acquire the fixed position information PSF easily and accurately. Therefore, a work load of an administrator of the fixed communication device 2 or the like for acquiring the fixed position information PSF can be alleviated.

Further, in the position correction system 100, the mobile communication device 1 stores the course information JC indicating the course CU, and acquires information indicating a position in the course CU as the contestant position information PSM.

Therefore, the information indicating the position in the course CU is acquired as the contestant position information PSM. Thus, as the contestant position information PSM, the position information indicating an appropriate position can be acquired.

Further, in the position correction system 100, the mobile communication device 1 includes the acceleration sensor 15, and detects movement of the contestant U, based on the detection result of the acceleration sensor 15. When the number SN of satellites that receive, from the GNSS system 5, the position signal SP whose SN ratio is the second threshold value TH2 or more is less than four, the contestant position information PSM is acquired based on the detection result of movement of the contestant U.

When the number SN of satellites that receive, from the GNSS system 5, the position signal SP whose SN ratio is the second threshold value TH2 or more is less than four, the reception condition from the GNSS system 5 is not satisfactory. Therefore, when the reception state from the GNSS system 5 is not satisfactory, movement of the contestant U is detected based on the detection result of the acceleration sensor 15, and the contestant position information PSM is acquired based on the detection result. Thus, the appropriate contestant position information PSM can be acquired.

Further, in the position correction system 100, the mobile communication device 1 stores the first identification information JD1 for identifying the mobile communication device 1. In a case in which the contestant position information PSM is acquired from the GNSS system 5, the number SN of satellites that receive, from the GNSS system 5, the position signal SP whose SN ratio is the second threshold value TH2 or more is less than four, the contestant position information PSM and the first identification information JD1 are transmitted to the server device 3 via the fixed communication device 2.

When the number SN of satellites that receive, from the GNSS system 5, the position signal SP whose SN ratio is the second threshold value TH2 or more is less than four, the reception condition from the GNSS system 5 is not satisfactory. Further, when the reception state from the GNSS system 5 is not satisfactory, it can also be estimated that a communication state with the server device 3 is not satisfactory. Therefore, the contestant position information PSM and the first identification information JD1 are transmitted to the server device 3 via the fixed communication device 2. Thus, the contestant position information PSM and the first identification information JD1 can securely be transmitted to the server device 3.

The position correction method according to the embodiment is a position correction method of the position correction system 100 including the mobile communication device 1 that is attached to the contestant U who participates in a marathon where the contestant U moves along the course CU, and acquires the contestant position information PSM indicating the position of the contestant U from the GNSS system 5, the fixed communication device 2 that communicates with the mobile communication device 1, is arranged at the specific position PP in the course CU, and acquires the fixed position information PSF indicating the specific position PP, and the server device 3 that communicates with the mobile communication device 1 and the fixed communication device 2, the position correction method including the acquisition step for acquiring the contestant position information PSM by the mobile communication device 1 when the contestant U arrives at the specific position PP, and the correction step for correcting the contestant position information PSM by the mobile communication device 1, based on the specific position PP, when the difference ΔL between the position of the contestant U that is indicated by the contestant position information PSM and the specific position PP is the first threshold value TH1 or more.

In other words, when the contestant U arrives at the specific position PP, it is determined whether the difference ΔL between the position of the contestant U that is indicated by the contestant position information PSM and the specific position PP is the first threshold value TH1 or more. Further, when the determination unit 112 determines that the difference ΔL is the first threshold value TH1 or more, the contestant position information PSM is corrected based on the specific position PP.

Therefore, the contestant position information PSM can be corrected appropriately.

### Other Embodiments

The embodiment described above is a preferred embodiment. However, the embodiment described above is not given for the purpose of limitation, and various modification and implementation are possible without departing from the main points thereof.

The embodiment describes a case where the “competition” is a marathon. However, the embodiment is not limited thereto. For example, the “competition” may be a triathlon. Further, for example, the “competition” may be a half marathon. For example, the “competition” may be a road bicycle race.

The embodiment describes a case where the contestant U is a contestant who runs at the front in a marathon. However, the embodiment is not limited thereto. The contestant U is only required to be a contestant participating in a marathon.

The embodiment describes a case where the “information processing device” is the server device 3. However, the embodiment is not limited thereto. The “information processing device” is only required to be a device including a communication function and an information processing function. For example, the “information processing device” may be a personal computer. Further, for example, the “information processing device” may be a tablet device or a smartphone.

The embodiment describes a case where the mobile communication device 1 includes the determination unit 112 and the correction unit 113. However, the embodiment is not limited thereto. The server device 3 includes a function corresponding to the determination unit 112 of the mobile communication device 1 and a function corresponding to the correction unit 113 of the mobile communication device 1.

In other words, the embodiment describes a case where the “position correction device” is the mobile communication device 1. However, the embodiment is not limited thereto. The “position correction device” may be the server device 3.

The embodiment describes a case where the mobile communication device 1 corresponding to the “first communication device” of the “position correction system” includes the determination unit 112 and the correction unit 113. However, the embodiment is not limited thereto. The server device 3 corresponding to the “information processing device” of the “position correction system” may include a function corresponding to the determination unit 112 and a function corresponding to the correction unit 113.

The embodiment describes a case where the mobile communication device 1 includes the acceleration sensor 15, and the detection unit 114 detects movement of the contestant U, based on the detection result of the acceleration sensor 15. However, the embodiment is not limited thereto. The mobile communication device 1 may include at least one of the acceleration sensor 15 or a gyro sensor. Further, the detection unit 114 may detect movement of the contestant U, based on a detection result of at least one of the acceleration sensor 15 or the gyro sensor.

Further, each of the functional components in FIG. 2 to FIG. 4 is illustrated as a functional configuration, and there is no particular limitation on specific embodiments. In other words, it is not necessary to mount hardware that corresponds individually to each of the functional components, and it may be possible to employ a configuration in which a single processor executes a program to realize the functions of a plurality of functional components. Further, in the embodiment described above, some of the functions enabled by software may be enabled by hardware, or some of the functions enabled by hardware may be enabled by software. In addition, the specific details of the configuration of each component of the mobile communication device 1, the fixed communication device 2, and the server device 3 may be modified as appropriate without departing from the main points of the present disclosure.

Further, the processing units of the flowchart in FIG. 5 are set by dividing the processing according to the main processing content in order to facilitate understanding of the processing in the mobile communication device 1. The present disclosure is not limited by a way of dividing of the processing units, or their names illustrated in the flowchart of FIG. 5. The processing can be divided into more pieces of processing units on the basis of the processing contents, and can be divided such that one processing unit includes more pieces of processing. Further, the order of the processes in the flowcharts described above is not limited to the example illustrated in the drawings.

Further, the position correction method of the position correction system 100 can be achieved by executing the control program PG corresponding to the position correction method of the position correction system 100 by the processor provided to each of the mobile communication device 1, the fixed communication device 2, and the server device 3. The processor corresponds to the first processor 11A to the third processor 31A. The first control program PG1 corresponds to the first control program PG1 to the third control program PG3.

Further, the control program PG can also be recorded in a recording medium recorded so as to be readable by a computer.

As the recording medium, magnetic and optical recording mediums or semiconductor memory devices may be used. Specifically, the recording medium includes a flexible disk, an HDD, a compact disk read only memory (CD-ROM), a DVD, a Blu-ray (registered trademark) Disc, a magneto-optical disk, a flash memory, a mobile-type or fixed-type recording medium such as a card-type recording medium. Further, the recording medium may be a non-volatile storage device such as an RAM, a ROM, or an HDD that is an internal storage device provided to each of the mobile communication device 1, the fixed communication device 2, and the server device 3.

It may be possible to achieve the position correction method of the position correction system 100 by storing the control program PG in the server device or the like and downloading the control program PG from the server device to each of the mobile communication device 1 and the fixed communication device 2.

What is claimed is:

1. A position correction device comprising:
a first acquisition unit attached to a contestant participating in a competition in which the contestant moves along a course, and configured to acquire, from a GNSS system, first position information indicating a position of the contestant;
a second acquisition unit arranged at a specific position in the course, and configured to acquire second position information from a second communication device that stores the second position information indicating the specific position;
a determination unit configured to determine whether a difference between a position of the contestant that is indicated by the first position information and the specific position is a first threshold value or more when the contestant arrives at the specific position; and
a correction unit configured to correct the first position information, based on the specific position, when the determination unit determines that the difference is the first threshold value or more.

2. The position correction device according to claim 1, wherein
when the determination unit determines that the difference is the first threshold value or more, the correction unit corrects the position indicated by the first position information to the specific position.

3. The position correction device according to claim 1, comprising
a transmission unit configured to transmit the first position information to an information processing device, wherein
when the determination unit determines that the difference is the first threshold value or more, the transmission unit transmits, to the information processing device, the first position information corrected and correction completion information indicating that the first position information is corrected by the correction unit.

4. The position correction device according to claim 1, wherein
the second position information is acquired from the GNSS system by the second communication device.

5. The position correction device according to claim 1, comprising
a course storage unit configured to store course information indicating the course, wherein
the first acquisition unit acquires information indicating a position in the course as the first position information.

6. The position correction device according to claim 1, comprising:
at least one of an acceleration sensor or a gyro sensor; and
a detection unit configured to detect movement of the contestant, based on a detection result of at least one of the acceleration sensor or the gyro sensor, wherein
in a case in which the first acquisition unit acquires the first position information from the GNSS system, when the number of satellites that receive, from the GNSS system, a position signal whose SN ratio is a second threshold value or more is less than four, the first acquisition unit acquires the first position information, based on a detection result of the detection unit.

7. The position correction device according to claim 3, comprising
an identification storage unit configured to store identification information for identifying the position correction device, wherein
in a case in which the first acquisition unit acquires the first position information from the GNSS system, when the number of satellites that receive, from the GNSS system, a position signal whose SN ratio is a second threshold value or more is less than four, the transmission unit transmits the first position information and the identification information to the information processing device via the second communication device.

8. A position correction system comprising:
a first communication device attached to a contestant participating in a competition in which the contestant moves along a course, and configured to acquire, from a GNSS system, first position information indicating a position of the contestant;
a second communication device arranged at a specific position in the course, and configured to communicate with the first communication device and acquire second position information indicating the specific position; and
an information processing device configured to communicate with the first communication device and the second communication device, wherein
when the contestant arrives at the specific position, the first communication device acquires the first position information, and
when a difference between a position of the contestant that is indicated by the first position information and the specific position is a first threshold value or more, at least one of the first communication device or the information processing device corrects the first position information, based on the specific position.

9. The position correction system according to claim 8, wherein
when the difference is the first threshold value or more, at least one of the first communication device or the information processing device corrects the position indicated by the first position information to the specific position.

10. The position correction system according to claim 8, wherein
the first communication device is configured to:
acquire the second position information from the second communication device;
determine whether a difference between a position of the contestant that is indicated by the first position information and the specific position is the first threshold value or more; and
transmit, to the information processing device, the first position information corrected and correction completion information indicating that the first position information is corrected, when the difference is the first threshold value or more.

11. The position correction system according to claim 8, wherein
the second position information is acquired from the GNSS system by the second communication device.

12. The position correction system according to claim 8, wherein
the first communication device is configured to:
store course information indicating the course; and
acquire information indicating a position in the course as the first position information.

13. The position correction system according to claim 8, wherein
the first communication device includes at least one of an acceleration sensor or a gyro sensor,
movement of the contestant is detected based on a detection result of at least one of the acceleration sensor or the gyro sensor, and
in a case in which the first position information is acquired from the GNSS system, when the number of satellites that receive, from the GNSS system, a position signal whose SN ratio is a second threshold value or more is less than four, the first position information is acquired based on a detection result of movement of the contestant.

14. The position correction system according to claim 10, wherein
the first communication device is configured to:
store identification information for identifying the first communication device; and
transmit the first position information and the identification information to the information processing device via the second communication device, in a case in which the first position information is acquired from the GNSS system, when the number of satellites that receive, from the GNSS system, a position signal whose SN ratio is a second threshold value or more is less than four.

15. A position correction method of a position correction system,
the position correction system including:
a first communication device attached to a contestant participating in a competition in which the contestant moves along a course, and configured to acquire, from a GNSS system, first position information indicating a position of the contestant;
a second communication device arranged at a specific position in the course, and configured to communicate with the first communication device and acquire second position information indicating the specific position; and
an information processing device configured to communicate with the first communication device and the second communication device,
the position correction method comprising:
acquiring the first position information by the first communication device when the contestant arrives at the specific position; and
correcting the first position information by at least one of the first communication device or the information processing device, based on the specific position, when a difference between a position of the contestant that is indicated by the first position information and the specific position is a first threshold value or more.
